(19) United States
(12) Patent Application Publication
(10) Pub. No.: US 2009/0278050 A1
(43) Pub. Date: Nov. 12, 2009

(54) STACKED DETECTORS

(75) Inventors: Ronald Steven McNabb, JR., Charlestown, MA (US); Richard F. Eilbert, Lincoln, MA (US)

Correspondence Address: FISH & RICHARDSON P.C., P.O. BOX 1022, MINNEAPOLIS, MN, 55440-1022, US

(73) Assignee: L-3 Communications Security and Detection Systems, Inc., Woburn, MA (US)

(21) Appl. No.: 12/463,116

(22) Filed: May 8, 2009

Related U.S. Application Data
(60) Provisional application No. 61/052,072, filed on May 9, 2008.

(51) Int. Cl. G01T 1/24

(52) U.S. Cl. 250/370.06

(57) ABSTRACT

A representation of an amount of energy incident on a radiation sensor formed from multiple sensing elements coupled together along a direction parallel to a direction of propagation of the incident radiation is received. The radiation sensor has an adjustable border positioned between any two of the multiple sensing elements. From the representation, an amount of energy incident on the radiation sensor is determined. A position of the border is selected based on the amount of energy incident on the radiation sensor. After selecting the position of the border, an absorption characteristic of a region imaged by the radiation sensor is determined.

### CROSS-REFERENCE TO RELATED APPLICATION

This application claims the benefit of U.S. Provisional Application No. 61/052,072, filed May 9, 2008 and titled IMAGING SYSTEM, which is incorporated by reference in its entirety.

### TECHNICAL FIELD

This disclosure relates to stacked detectors.

### BACKGROUND

Two single-piece detectors may be coupled at a fixed location such that the detector is optimized for imaging materials of one particular density.

### SUMMARY

Multiple sensing elements are coupled to form a radiation sensor (a stacked detector). In some implementations, the radiation sensor has an adjustable border that is configured to be positioned between any of two of the multiple sensing elements. The border defines a front portion of the radiation detector and a second portion of the radiation detector.

In some implementations, one of the sensing elements itself is a set of coupled sensing elements. Data from the set of coupled sensing elements and a single-piece sensing element may generate, respectively, a high spatial resolution image and a high-penetration image. These images may be combined into an image of high spatial resolution and high penetration.

In one general aspect, a system for material discrimination includes multiple sensing elements coupled together to form a radiation sensor. The multiple sensing elements are coupled together along a direction parallel to a direction of propagation of radiation incident on the radiation sensor. An adjustable border is configured to be positioned between any two of the multiple sensing elements. The border defines a front region that includes a first set of coupled sensing elements and a back region that includes a second set of coupled sensing elements. A processor coupled to the radiation sensor is operable to receive an indication of an amount of energy incident on the radiation sensor, and select a position of the border based on the amount of the energy.

Implementations may include one or more of the following features. The amount of energy incident on the radiation sensor may be the total amount of energy incident on the multiple coupled sensing elements. The energy incident on the radiation sensor may be radiation that has traveled through a region, and the processor may be further operable to generate an image of the region based on the amount of energy incident on the radiation sensor. The processor may be further operable to estimate a density of the region based on the image, and the position of the border is selected based on the estimated density. To determine an amount of energy incident on the radiation sensor, the processor may be operable to determine a distribution of energy incident on the sensing elements. The distribution may be an amount of energy incident on each of the sensing elements, and the processor may be operable to select the position of the border based on the distribution of energy. To select the position of the border, the processor may be further operable to determine a comparative value of the energy incident on a sensing element with respect to the energy incident on the remaining sensing elements. The comparative value may be a ratio.

One of the first set of coupled elements and the second set of coupled elements may be a single sensing element. The first set of couple sensing elements and the second set of sensing elements may include the same number of sensing elements. Each of the coupled sensing elements may generate a signal representing an amount of energy incident on the sensing element, and each of the coupled sensing elements may be individually coupled to the processor.

One of the coupled sensing elements may be a filter that modifies a spectral energy or intensity of radiation passing through the filter. The multiple sensing elements are coupled together by a physical connection. Each of the multiple sensing elements has the same thickness in the direction of propagation. At least one of the multiple sensing elements may be an array of sensing elements arranged within a plane having a normal direction that is parallel to a direction of propagation of the incident radiation.

In another general aspect, a system for material discrimination includes a single-beam source of x-ray radiation having an energy spectrum and a peak energy and a radiation sensor. The radiation sensor includes multiple sensing elements that are responsive to incident radiation and coupled together to form the radiation sensor, and an adjustable border that is configured to be positioned between any two of the multiple sensing elements, the border defining a front region including a first set of coupled sensing elements and a back region including a second set of coupled sensing elements. A processor coupled to the radiation sensor is operable to receive an indication of an amount of energy incident on the radiation sensor, and select a position of the border based on the amount of the energy.

Implementations may include one or more of the follow features. The energy incident on the radiation sensor may emanate from a region, and the processor may be further operable to determine a ratio of an amount of energy incident on the front region of the radiation sensor to the amount of energy incident on the back region of the detector, and to determine an effective atomic number of the material based on the ratio.

In another general aspect, a representation of an amount of energy incident on a radiation sensor formed from multiple sensing elements coupled together along a direction parallel to a direction of propagation of the incident radiation is received. The radiation sensor has an adjustable border positioned between any two of the multiple sensing elements. From the representation, an amount of energy incident on the radiation sensor is determined. The radiation emanates from a region scanned by a single-beam x-ray source. A position of the border is selected based on the amount of energy incident on the radiation sensor. After selecting the position of the border, an absorption characteristic of a region imaged by the radiation sensor is determined.

Implementations may include one or more of the following features. Determining an amount of energy incident on the radiation sensor may include determining a distribution, among the coupled sensors, of the amount of energy incident on the radiation sensor. The absorption characteristic of the region may vary, and a second position of the border may be selected to account for the variation. An image may be generated based on the amount of energy incident on the radiation sensor. The image may represent an amount of attenuation caused by an object in the region imaged by the sensing elements. A density of the object may be estimated based on the image, and the position of the border may be selected based on the density.

In another general aspect, a device for imaging a region includes a first sensing element having an active area within a first plane that defines a normal direction, and a set of sensing elements arranged relative to each other within a second plane that is displaced laterally, in the normal direction, relative to the first plane. The first sensing element and the set of sensing elements are penetrable by x-ray radiation, data from the set of sensing elements produces an image of higher spatial resolution than an image produced by the first sensing element, data from the first sensing element produces an image of higher penetration than an image produced by the set of sensing elements, and the active area of the first sensing element is larger than any of the sensing elements included in the set of sensing elements.

Implementations may include one or more of the following features. A first interface may be coupled to the first sensing element and configured to provide an indication of an amount of radiation incident on the active area. A second interface may be coupled to each sensing element in the set of sensing elements and configured to provide an indication of an amount of radiation incident on the set of sensing elements. The device may include a processor operable to receive the indication from the first interface, receive the indication from the second interface, generate a high-penetration image of a region based on the indication from the first interface, generate a high-spatial resolution image of the region based on the indication from the second interface, and combine the high-penetration image and the high-spatial resolution image.

Implementations may include one or more of the following features. The first sensing element and the set of sensing elements may be physically coupled. The first plane may be parallel to the second plane.

In another general aspect, an indication of an amount of x-ray radiation incident on the set of sensing elements is received from a set of sensing elements positioned relative to an imaged region. An indication of an amount of x-ray radiation incident on the second sensor is received, from a second sensor that is laterally displaced from the set of sensing elements along direction parallel to a direction of propagation of the incident x-ray radiation and coupled to the sensing elements. A first image of the imaged region from the indication of the amount of x-ray radiation incident on the set of sensing elements is generated. A second image of the imaged region from the indication of the amount of x-ray radiation incident on the first sensor is generated. The first image has a higher spatial resolution than the second image and the second image having a higher penetration than the first image. The first image and the second image are combined to produce a combined image having high spatial resolution and high penetration.

Implementations may include one or more of the following features. An attenuation caused by a portion of the imaged region represented by a pixel of the first image and a pixel of the second image may be determined. A weighting based on the attenuation may be calculated. Combining the first image and the second image may include applying the weighting to a corresponding pixel of the first image, applying the weighting to a corresponding pixel of the second image, and generating a combined image from the weighed pixels.

Implementations of any of the techniques described above may include a method, a process, a system, a device, an apparatus, or instructions stored on a computer-readable storage medium. The details of one or more implementations are set forth in the accompanying drawings and the description below. Other features will be apparent from the description and drawings, and from the claims.

### DESCRIPTION OF THE FIGURES

FIG. 1 shows a perspective view of an example radiation sensor system that includes a radiation sensor having an adjustable border.

FIGS. 2A and 2B show a plan view of an example material discrimination system that includes the radiation sensor of FIG. 1 at two different times.

FIG. 3 shows a block diagram of an example system that includes a radiation sensor having an adjustable border.

FIG. 4 shows an example process for determining a characteristic of a region using a radiation sensor that has an adjustable border.

FIGS. 5A and 7A show a side view of an example radiation sensor having a partitioned sensing element coupled to a non-partitioned sensing element.

FIGS. 5B and 7B show a front view of the example radiation sensor of FIG. 5A.

FIG. 6 shows a perspective view of an example radiation sensor system that includes the radiation sensor of FIGS. 5A and 5B.

FIG. 8 shows an example process for generating an image having high spatial resolution and high penetration.

### DETAILED DESCRIPTION

A stack of more than two detectors, each of which produces a signal when struck by x-ray radiation, form a stacked detector 105. The stacked detector 105 may be referred to as a sensor 105. The signal from each detector (or sensing element) included in the sensor 105 is separately read out and provided to a processor for analysis. The analysis may include determining a distribution of an amount of x-ray radiation deposited on the sensor 105 by displaying an amount of energy deposited on each of the detectors included in the sensor 105. A dividing line 125 is selected based on the analysis. The dividing line 125 may be referred to as an adjustable border. The adjustable border 125 defines a front portion 110 and a back portion 115. The front portion 110 may be referred to as a front detector, and the back portion 115 may be referred to as a back detector.

Material discrimination may be achieved in an x-ray system by scanning a line through an object 123 with x-rays of two different energies. The line through the object 123 is a line through the object 123 from a source system (not shown) to the detector 105. Scanning the object 123 with the two different energies and then comparing the attenuation of the two different energies caused by passing the x-rays through the object gives the effective atomic number (Z) of all of the material in that line averaged together. Because the effective atomic number is a characteristic of the material, the effective atomic number may be used to distinguish the material from other materials.

Some x-ray systems perform material discrimination by stacking two detectors, with one detector being behind the other. However, in these systems, the dividing line between the detectors is fixed because the stack includes only two detectors. The front detector is more sensitive to low-energy x-rays because the low energy x-rays are more likely to stop in a thin piece of material and/or low-energy x-rays do not have sufficient energy to penetrate through the front detector to reach the back detector. However, the high energy x-rays penetrate through the front detector and reach the back detector. As a result, the back detector is more sensitive to the more penetrating high-energy x-rays. Because of the differences in sensitivity between the front and back detector, two images are created from a single scan. One of the images is an image of the object with the high-energy x-ray and the other image is an image of the object with the low-energy x-ray. The image of the object with the high energy x-ray may be referred to as high(H), and the image of the object created with the low energy x-ray may be referred to as low(L) are created.

In contrast, the techniques discussed below allow adjustment of the border 125 (or dividing line) between the front detector 110 and the back detector 115 through analysis of the data read from each of the detectors in the stacked detectors 105. In some implementations, a lookup table is used to determine the thickness and effective atomic number along the line between source and detector based on the measured H and L values. In particular, data from each detector included in a stack of more than two detectors is analyzed and used to improve material discrimination performance. The detector stacks may be laid out in a one dimensional line or configured in a two-dimensional array so that an image can be formed from a single exposure of x-rays. The data taken from the detectors in the stacked detectors 105 includes the x-ray signal in each element of every stack. Thus, if an imaging system includes a two-dimensional array of stacked detectors, for example a one-hundred by one-hundred array of stacked detectors such as the stacked detector 105, and each of the stacked detectors in the array are for detectors deep, forty thousand separate values are read out from the two-dimensional array of detector stacks. The detectors in a stack may be of different materials and thicknesses.

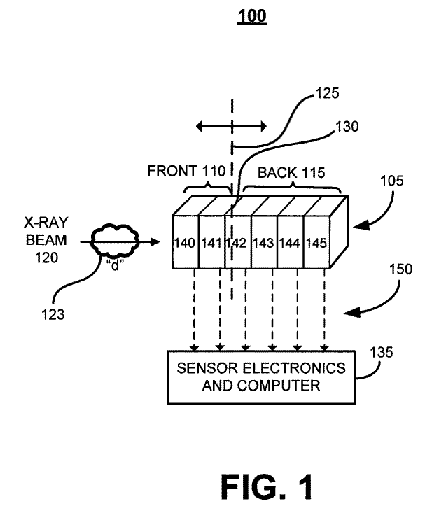

Once the data is read out from each detector in the stacked detector 105, the data is analyzed to determine the best way to obtain an H and L value for each stacked detectors. This is done by choosing which of the detectors in the front of the stack to use for the L value and which detectors at the back to use for the H value. In the example shown in FIG. 1, sensing elements 140 and 141 are included in the front detector 110 and sensing elements 142-145 are included in the back detector 115. The determination of which detectors to include in the front 110 and which to include in the back 115 may be done based on the attenuation seen in the stacked detectors 105 or some combination of the individual detectors in the stack 105. In the case of a two-dimensional array of stacked detectors 105, the attenuations in nearby pixels (nearby stacked detectors) also may be taken into account. Once the dividing line is determined, the H and L values for each pixel are determined by summing the values from the front(L) and back(H) of the stacked detectors. The H and L values are compared to a lookup table to determine the effective Z of the material on that pixel's line of sight. Different lookup tables may be used for different front/back detector divisions that result from different placement of the adjustable border (or dividing line).

Referring to FIG. 1, an example radiation sensor system 100 for material discrimination is shown. The radiation sensor system 100 includes the radiation sensor 105, which is sensitive to different parts of the x-ray spectrum. The radiation sensor 105 has a front portion 110 and a back portion 115 that is positioned behind the front portion 110 along a direction of propagation “d” of an x-ray beam 120. The x-ray beam 120 strikes the sensor 105 after passing through an object 123. The front portion 110 and the back portion 115 are defined by a border 125 having a position 130. The position 130 of the border 125 is adjustable and determined by a sensor electronics and computer 135, and each of the sensing elements 140-145 are individually coupled to the sensor electronics and computer 135 though coupling 150.

The front portion 110 and the back portion 115 are arranged one behind the other such that photons in the x-ray beam 120 strike the front portion 110 before striking the back portion 115. The portions of the x-ray spectrum to which the front portion 110 and the back portion 115 are sensitive is determined by the thickness of the front portion 110 and the back portion 115, and the thickness of the portions 110 and 115 is determined by the position 130 of the border 125.

In particular, the amount of attenuation of low-energy radiation caused by the object 123 is determined using data from the front portion 110, and the amount of attenuation of high-energy radiation caused by the object 123 is determined using data from the back portion 115. The ratio of these attenuations is proportional to the effective atomic number of the object 123.

An effective atomic number of a material may be determined by the attenuation caused by the material when x-rays of different energies pass through the material. The effective atomic number is a characteristic of the material and may be used to distinguish the material from other materials. Material discrimination is based on the relative weight of two processes (Compton scatter and pair production), which have different atomic number (Z) dependence. Briefly, dense materials that readily absorb x-rays, such as metals, tend to have relatively high effective atomic numbers (for example, above 20). These materials absorb both lower-energy x-rays and higher-energy x-rays. Materials that absorb x-rays less readily, such as organic materials and plastics, tend to have lower effective atomic numbers (for example, between 5 and 12). These materials tend to absorb fewer low energy x-rays as compared to materials having a higher effective atomic number. Organic materials may include items such as food and clothing, and inorganic materials may include items made from materials such as metal.

In some implementations, the x-ray beam 120 is a single beam. In these implementations, the x-ray beam 120 is not monochromatic; rather, the beam 120 includes a spectrum composed of many different x-ray energies. Relatively high-energy radiation penetrates more deeply into the sensor 105 in the “d” direction than relatively low-energy radiation penetrates. Thus, positioning the back portion 115 behind the front portion 110 allows differentiation between attenuations of x-ray photons having energies in the relatively low end of the energy spectrum (those photons deposited in the front portion 110) from attenuations of x-ray photons having energies in the relatively high end of the energy spectrum (those photons deposited in the back portion 115). In other implementations, two different x-ray beams of different energies may be used.

Almost all x-ray photons in the beam 120 reach the front portion 110, and relatively low-energy photons are deposited on the front portion 110 rather than penetrating through to the back portion 115. However, photons with relatively high energy pass through the front portion 110 and reach the back portion 115. Thus, the a signal produced as a result of the relatively low-energy photons striking the front portion 110 is more strongly weighted to represent the amount of low-energy photons striking the sensor 105, and a signal produced as a result of the relatively high-energy photons striking the back portion 115 is more strongly weighted to represent the number of high-energy photons striking the sensor 105. Accordingly, by measuring the intensity of the signal from the sensing elements 140 and 141 that make up the front portion 110 and the signal from the sensing elements 142-145 that make up the back portion 115, an amount of low-energy radiation and an amount of high-energy radiation may be respectively inferred. The effective atomic number of the object 123 may be determined from the ratio of the high-energy radiation attenuation to the low-energy radiation attenuation.

Because the position 130 of the border 125 is adjustable, the thickness of the front portion 110 and the back portion 115 may be changed depending on the density of the object 123. Thus, the sensor 105 may be used to image a variety of objects of various densities, and the sensor 105 may be used to image a region that includes unexpected variations in density. This is in contrast to a detector that includes just two sensing elements coupled together with a border that is predefined and fixed at the point of coupling. As explained in more detail below, to more effectively image a low-density material, the thickness of the front portion 110 in the “d” direction is reduced. To more effectively image a high-density material, the thickness of the front portion 110 in the “d” direction is increased.

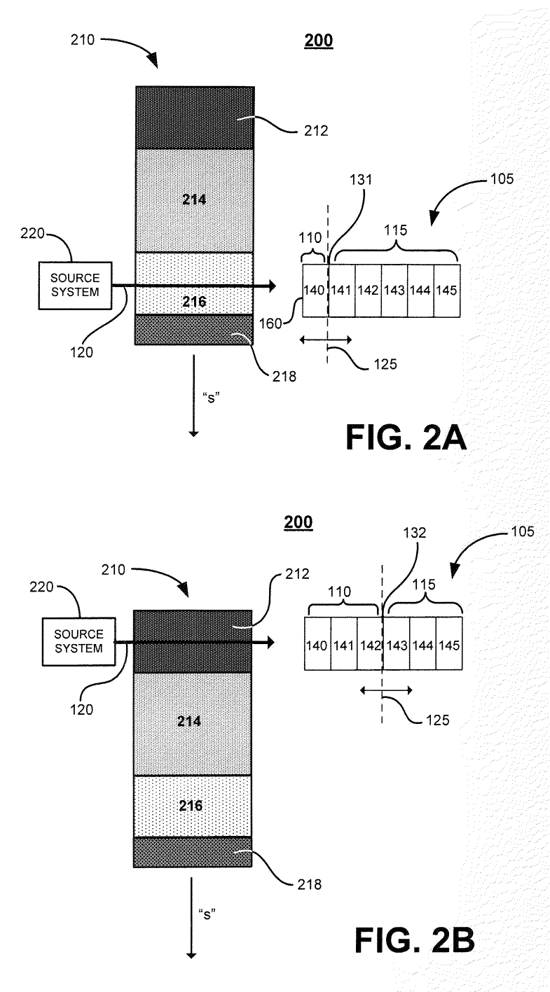

FIGS. 2A and 2B show a plan view of an example material discrimination system 200 that includes the radiation sensor system 100 of FIG. 1 at two different times. The system 200 is a system that may be used for material discrimination. An object 210 passes through the system 200 in a direction “s” and is imaged by the sensor 105. FIG. 2A shows the object 210 at a time t₁, and FIG. 2B shows the object 210 at a time t₂. After the time t₁, data from the sensor 105 is received and analyzed by the sensor electronics and computer 135 to determine a position of the adjustable border 125. As a result of the analysis, the border 125 changes from a position 131 at the time t₁ to a position 132 at a time t₂.

In greater detail, the x-ray beam 120 is produced from a source system 220 and scans the object 210 as the object passes through the system 200 in a scan direction “s.” In some implementations, the source system 220 scans (moves) the beam 120 along the object 210. In other implementations (such as the example of FIGS. 2A and 2B), the object moves relative to the source system 220. The object 210 is an object that includes mid-density regions 214 and 218, a low-density region 216, and a high-density region 212. The high-density region 212 may include a material with a relatively high atomic number, such as lead. The mid-density regions 214 and 218 may include materials such as organic materials or plastics. The low-density region 216 may include materials such as fibrous cloth or no materials at all.

Referring to FIG. 2A, at the time t1, the x-ray beam 120 irradiates the low-density region 216, is attenuated by the materials in the low-density region 216 and emerges as attenuated x-ray radiation that strikes the front surface 160 of the sensor 105. Because the density of the region 216 is relatively low, most of the x-ray photons in the beam 120 pass through the object 123 and strike the front surface 160 of the sensor 105. Thus, the photons striking the front surface 160 include photons having energies of almost all of the energies in the x-ray beam 120, including a relatively substantial number of low-energy photons that do not penetrate deeply into the sensor 105. As a result, to ensure that the sensor 105 produces a signal that is attributable to low-energy photons and a signal that is attributable to high-energy photons, the border 125 is located at a position 131 that is between the sensing element 140 and the sensing element 141. Thus, the front portion 110 is the sensing element 140, and the back portion 115 includes the sensing elements 141-145.

Referring to FIG. 2B, at the time t₂, the x-ray beam 120 irradiates the high-density region 212. The x-ray beam 120 passes through the high-density region 212 and emerges as attenuated x-ray radiation that strikes the front surface 160 of the sensor 105. Because the region 212 includes high-density material, such as lead, the region 212 attenuates the x-ray beam 120 more than the low-density region 216 attenuates the x-ray beam 120. As a result, the photons striking the front surface 160 are relatively high-energy photons that are energetic enough to penetrate the region 212. Most of the relatively high-energy photons penetrate relatively far into the sensor 105. Thus, if the border 125 remained in the position 131 as shown in the example of FIG. 2A, most of the photons would pass through the front portion 110 without being deposited. As a result, a signal representing the relatively-low energy photons would not be produced, and, in turn, determination of the effective atomic number of the portion 212 would be challenging.

However, because the border 125 is adjustable, rather than remaining at the position 131, at the time t₂ the border 125 moves to a position 132 that is between the sensing element 142 and the sensing element 143. At time t₂, the front portion 110 includes the sensing elements 140, 141, and 142 and back portion 115 includes the sensing elements 143, 144, and 145. Thus, the front portion 110 and the back portion 115 are of similar thickness along the direction “d.” This configuration allows a sufficient amount of lower-energy photons to be deposited in the front portion 110 to produce a signal that represents the amount of lower-energy photons that emerge from the object 123. The higher-energy photons included in the attenuated x-ray beam penetrate through the front portion 110 and are deposited in the back portion 115. These higher-energy photons are deposited on one of the sensing elements 143, 144, and 145 and result in the production of a signal from the back portion 115 that represents the amount of higher-energy photons in the attenuated x-ray beam.

Thus, by repositioning the border from the position 131 at the time t₁ to the position 132 at the time t₂, the sensor 105 is able to measure the amount of attenuation of relatively high-energy photons and relatively low-energy photons caused by both the low-density region 216 and the high-density region 212. Despite the differences in density, the effective atomic number for both the low-density region 216 and the high-density region 212 may be determined using the same sensor 105.

As a result, as compared to a detector that includes just two sensing elements coupled at a fixed point with a fixed front portion and a fixed back portion, the sensor 105 has an adjustable border 125 that allows the front portion 110 and the back portion 115 to vary.

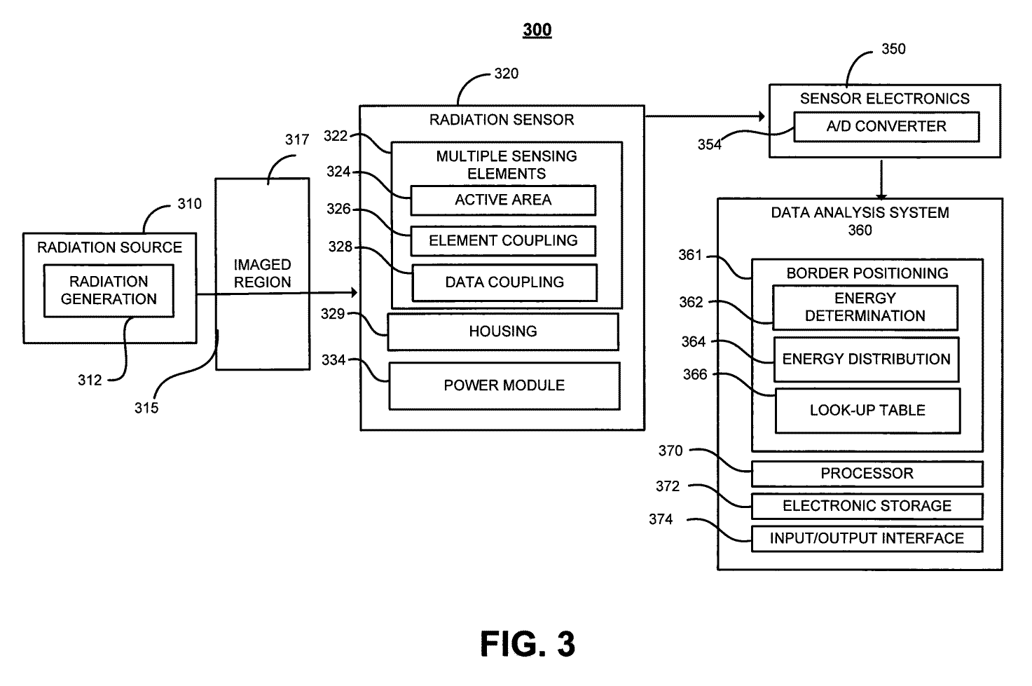

FIG. 3 shows a block diagram of an example material discrimination system 300. The system 300 is an example implementation of a system that includes the example radiation sensor system of FIG. 1. The system 300 includes a radiation source 310 that produces a beam of radiation 315. The beam 315 enters an imaged region 317, the beam 315 is attenuated by material that is in the imaged region 317, and attenuated radiation is detected by a radiation sensor 320. The radiation sensor 320 may be similar to the sensor 105 discussed above with respect to FIGS. 1, 2A, and 2B. Sensor electronics 350 receives data from the sensor 320, and a data analysis system selects a position of an adjustable border of the sensor 320 based on information from the sensor electronics 350.

The radiation source 310 includes a radiation generator 312 that produces the beam of radiation 315. The beam of radiation 315 may be an x-ray beam, and the radiation generator 312 may be an x-ray generator such as a linac (for implementations such as cargo scanning in which a high-energy x-ray beam is used). The beam 315 may be pulsed or continuous, and the beam 315 is defined by an energy spectrum and a maximum energy. In implementations in which the beam 315 is an x-ray beam, the x-ray beam includes photons, each of which have an energy within the spectrum up to the maximum energy. The maximum energy of the beam 315 may be, for example 1-12 MeV for implementations used to scan cargos that are housed in thick-walled metal containers. The system 300 also may be used to screen luggage, and in this case the maximum energy of the beam 315 may be about 160 keV.

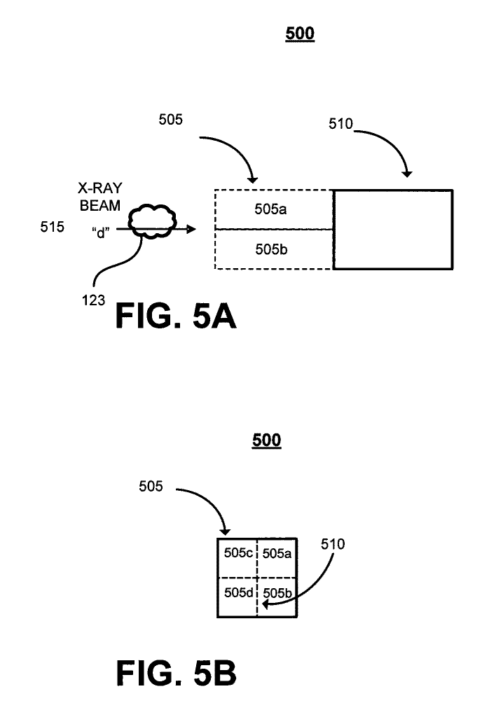

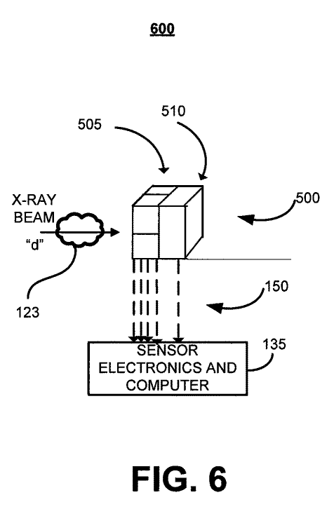

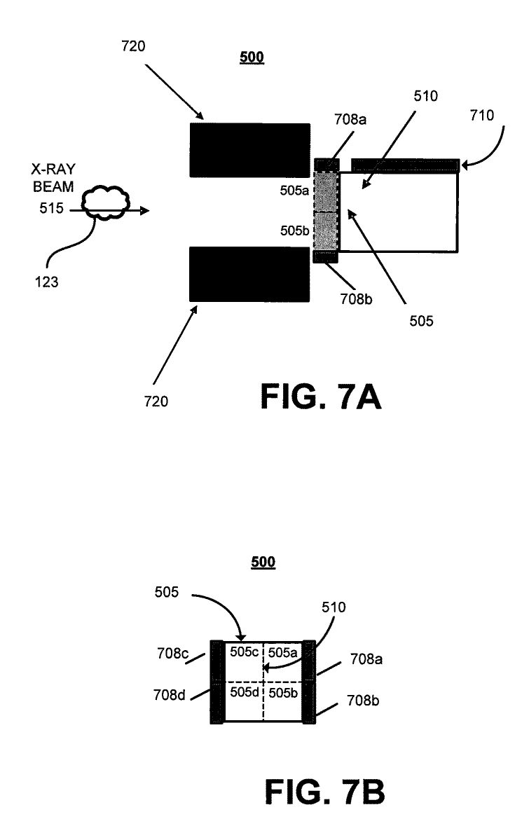

The radiation sensor 320 may be a sensor similar to the sensor 105 discussed above. The sensor 320 includes multiple sensing elements 322. The multiple sensing elements 322 include more than two multiple sensing elements 322 coupled together to form the sensor 320. The sensing elements 322 are arranged, one behind another, along the direction of propagation of the beam 315. In some implementations, the sensing elements 322 are directly behind one another, and in some implementations, the sensing elements 322 are vertically offset from a path defined by the beam 315. In some implementations, one or more of the sensing elements 322 may itself include multiple sensing elements that are arranged within a plane in a grid-like pattern. An example of multiple sensing elements arranged within a plane is shown in FIGS. 5A and 5B; FIG. 6; and FIGS. 7A and 7B.

Each of the multiple sensing elements 322 includes an active area 324 that produces a signal, such as an optical signal or an electrical signal, in response to being struck by radiation of sufficient energy. In some implementations, each of the sensing elements 322 are scintillating crystals (which may be referred to as scintillators). Scintillators produce visible light in response to being struck by ionizing radiation, and the intensity of the visible light is proportional to the intensity of the radiation that strikes the scintillator. The ionizing radiation may be a charged particle such as electrons and heavy charged particles, or neutral particles such as photons and neutrons having sufficient energy to induce ionization in the scintillator crystal. In examples in which the beam 315 is an x-ray beam, the ionizing radiation includes photons that pass through the region 317. The signal produced by the scintillator in this case is proportional to the number of photons incident on the scintillator. The scintillating crystal may be a material such as cadmium tungstate (CdWO₄ or CWO), thallium-activated cesium iodide (CsI(TI)), cadmium zinc telluride (CZT), and rare-earth phosphors.

Each of the multiple sensing elements 322 also includes an element coupling 326 and a data coupling 328. The element coupling 326 allows a sensing element to be coupled to another sensing element. The element coupling 326 may be, for example, a coupling that forms a direct physical connection between the sensing elements. In these examples, the coupling may be glue or another adhesive material. In other examples, the element coupling 326 may be a coupling that connects an active area 324 of one sensing element to the active area 324 of another sensing element in a non-physical manner. For example, the element coupling 326 may be an electromagnetic coupling between two sensing elements that exists as photons pass through one sensing element and into another sensing element. In these examples, the active areas 324 of the different sensing elements do not necessarily touch each other.

Additionally, each of the multiple sensing elements 322 includes a data coupling 328 that couples the sensing element to the sensor electronics 350. The data coupling 328 may be arranged similar to the coupling 150 shown in FIG. 1. The data coupling 328 may be a direct physical coupling or a non-physically coupling that allows a sensing element to pass data to the sensor electronics 350. In the example in which the sensing elements 322 are scintillators, each of the sensing elements 322 is individually coupled (for example, optically coupled or coupled by direct physical connection) to an optical detector that is sensitive to visible light. The optical detector produces an electrical signal that is proportional to the amount of visible light sensed by the optical detector. The optical detector may be, for example, a photomultiplier tube (PMT) or a photodiode. Thus, this implementation includes an optical detector for each of the sensing elements 322, and the output of the optical detector represents the amount of x-ray radiation incident on the sensing element to which the detector is coupled. The output of the optical detector is connected to the sensor electronics 350 such that the sensor electronics 350 receives a representation of the amount of energy deposited on each of the sensing elements 322.

The sensor 320 also includes a housing 329 that protects the multiple sensing elements 322. In some implementations, each sensing element has a housing, and the housings of the various sensing elements 322 are connectable to form the housing 329 for the sensor 320. A power module 334 provides power to the components of the sensor 320.

The system 300 also includes the sensor electronics 350. The sensor electronics 350 receives data from the sensor 320 and processes the data into data that is provided to the data analysis system 360. The sensor electronics 350 includes an analog-to-digital converter 354. The sensor electronics 350 receive a signal (such as an electrical signal produced by a photodiode) from the data coupling 328. The signal from the data coupling 328 is a representation of an amount of radiation deposited on one of the sensor elements included in the multiple sensing elements 322. In implementations in which the signal from the data coupling 328 is an analog signal, the sensor electronics 350 includes an analog-to-digital converter (A/D) 354 that converts the analog signal to a digital signal.

Data from the sensor electronics 350 is passed to the data analysis system 360. The data analysis system 360 determines a position of the border based on the distribution of energy among the sensing elements 322. The data analysis system 360 includes an energy determination module 362 and an energy distribution module 364. The energy determination module 362 determines an amount of energy deposited on each of the sensing elements 322 from the data received from the sensor electronics 350. As discussed above, the amount of energy deposited on each of the sensing elements provides an indication of an amount of photons of a particular energy incident on the sensor 230. Thus, the energy spectrum of the attenuated energy that emerges from the region 317 may be determined from the indication of the energy deposited on each of the multiple sensing elements 322.

Additionally, the energy determination module 362 may determine a total amount of energy deposited on the sensor 320 by summing all of the energy deposited on each of the sensing element 422. Using the sum of all of the energy deposited on each sensing element, the energy determination module 362 may produce an image of the region 317. The energy determination module 362 also uses the representations from the sensing elements that are included in the front portion and those that are included in the back portion to determine a ratio of attenuation of high-energy radiation and low-energy radiation in order to determine the effective atomic number of the material in the region 317. To determine the amount of attenuation, the energy determination module 362 calculates the amount of energy deposited on one or more of the sensing elements 322 and divides (or otherwise compares) that amount to the original intensity of the beam 315. The intensity of the beam 315 is known from the radiation source 310 and the radiation generation 312.

The data analysis system 360 also includes an energy distribution module 364 that determines a distribution of the amount of energy deposited on each of the multiple sensing elements 322. The energy distribution module 364 determines how the energy that reaches the sensor 320 is distributed among the multiple sensing elements 322. The energy distribution module 364 determines the position of the adjustable border based on the distribution of the energy. For example, and referring to FIG. 1, if the energy is concentrated in the sensing elements that are located furthest from the object 123 (for example, the sensing elements 144 and 145 have the highest amount of deposited energy), the border is positioned more towards the sensing element 145. For example, the border 330 may be positioned between the elements 144 and 145.

However, if the distribution shows that relatively more energy is deposited in the elements nearer to the front surface 160, that indicates that the radiation sensed by the sensor 320 includes a substantial amount of low-energy photons and the object 123 is likely a low-density material. In this example, the energy distribution module 364 places the border closer to the front surface 160, for example, between the sensing elements 141 and 142.

Thus, the energy distribution module 364 may be used to determine a position of the adjustable border. In some implementations, the data analysis system 360 includes a look-up table 366 that correlates an amount of energy deposited on each of the sensing elements 322 with corresponding positions of the border.

The data analysis system 360 also includes the processor 370, the electronic storage 372, and the input/output interface 374. The processor 370 may be a processor suitable for the execution of a computer program such as a general or special purpose microprocessor, and any one or more processors of any kind of digital computer. Generally, a processor receives instructions and data from a read-only memory or a random access memory or both. The electronic storage 372 stores instructions, perhaps as a computer program, that, when executed, cause the processor to communicate with other components in the sensor electronics 350. For example, the electronic storage 372 may store instructions that cause the energy distribution module 364 to determine a distribution of energy deposited among the multiple sensing elements 322 and to select a position of the adjustable border. The electronic storage 372 also may store data for inclusion in the look-up table 366. The electronic storage 372 may be volatile memory, such as RAM. In some implementations, and the electronic storage 372 may include both non-volatile and volatile portions or components.

The input/output interface 374 is an interface that allows data and/or commands to be input to the sensor electronics 350 and/or read from the sensor electronics 350. The input/output interface 374 may receive data from a tactile device such as a keyboard, a mouse, a communications port, or a display. The input/output interface 374 also may include software that allows communication between the sensor 320 and the sensor electronics 350 and/or between the sensor electronics 350 and an external device. The input/output interface 374 may be used to display the amount of x-ray radiation deposited on each of the sensing elements in the sensor 320.

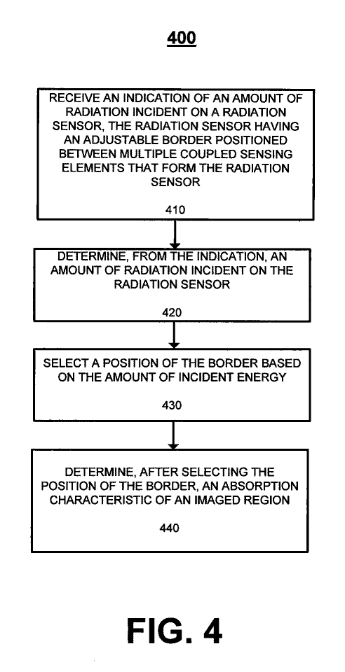

Referring to FIG. 4, an example process for determining a characteristic of a region using a radiation sensor system that includes a radiation sensor having an adjustable border is shown. The process 400 may be performed using a system such as the system 300 discussed above with respect to FIG. 3. For example, the process 400 may be performed using the data analysis system 360.

An indication of an amount of radiation incident on a radiation sensor is received (410). The radiation sensor is a stack of coupled detectors that has a front portion and a back portion that are defined by the position of an adjustable border. The adjustable border is positioned between two of multiple sensing elements that are coupled to form the radiation sensor. The radiation sensor may be a sensor such as the sensor 105 formed by stacking or coupling multiple sensing elements. The indication may be a representation of an amount of energy deposited on one, all, or some of the sensing elements that are included in the radiation sensor.

An amount of radiation incident on the radiation sensor may be determined from the indication (420). A distribution of the energy as deposited among the multiple sensing elements may be determined from the amount of the amount of deposited energy. A position of the adjustable border is selected based on the amount of incident energy (430). The position may be selected based on how the energy is distributed among the multiple coupled sensing elements. For example, if the energy that is incident on the sensor is primarily deposited on sensing elements that are relatively far from the imaged region, the energy incident on the sensor may include mostly high-energy photons. In these examples, the position of the border may be selected to be between two of the sensing elements that are in the center of the sensor such that the border is approximately in the middle of the sensor.

After selecting the position of the border, an absorption characteristic of an imaged region is determined (440). The imaged region may be an object such as the object 123 or the object 210, or the imaged region may be a larger space that includes an object, or multiple objects. The objects and/or the imaged region may be made of multiple materials each having a different density and effective atomic number. The absorption characteristic may be an amount of attenuation caused by the imaged object. In some examples, the absorption characteristic is an effective atomic number of the imaged object determined as discussed above. The position of the border may change to a second, and different, position in response to a change in density of the imaged object. For example, the position of the border may change as shown and discussed with respect to FIGS. 2A and 2B.

Thus, as discussed above, a stacked detector having more than two sensing elements forms a detector that has a front detector that is sensitive to relatively low-energy photons, and a back detector that is sensitive to relatively high-energy photons. The front and back detectors are defined by a dividing line that may be positioned between any two of the sensing elements. The position is determined based on the spatial distribution amount of the amount of radiation received along the stacked detector.

In some implementations, a stacked detector may include a layer that has more than one sensing element. In these implementations, the stacked detector may have just two layers, one of which has multiple sensing elements. As discussed below, such an implementation may be used to generate an image that has both high spatial resolution and high penetration.

Two properties of an x-ray imaging system are penetration and resolution. As discussed below, a detector that has high penetration usually has low spatial resolution. Conversely, a detector with low penetration typically has high spatial resolution. Accordingly, a trade-off exists between maximizing penetration through the object on the one hand and maximizing spatial resolution on the other.

Penetration is a measure of a thickness of material through which the x-ray imaging system is able to image an object. Penetration may be determined from a number of x-ray photons that penetrate through (or pass through) an imaged object and impact a single detector. A detector that has a larger active area (an area sensitive to x-ray photons) detects a larger number of x-ray photons than a detector that has a smaller active area. Additionally, detection of a larger number of x-ray photons causes the detector to produce a detection of higher intensity. Thus, a detector with a larger active area has a higher penetration than a detector with a smaller active area, and the detector with the larger active area may image through thicker materials. Resolution is a measure of the smallest details that a system can consistently resolve. Resolution is primarily determined by the size of the detectors used, with smaller detectors providing better resolution.

FIG. 5A shows a side view of an example radiation sensor 500 having multiple sensing elements coupled to a single sensing element, and FIG. 5B shows a front view of the example radiation sensor 500. The radiation sensor 500 provides high-resolution imaging of the object 123 with a set of small detectors while also increasing an amount of detected signal by using a single large detector coupled to the set of small detectors. The radiation sensor 500 is similar to the stacked radiation sensor 105 discussed above, except the radiation sensor 500 may include just two sensing elements, the sensing element 505 and the sensing element 510.

The radiation sensor 500 includes a sensing element 505 that includes multiple, smaller sensing elements 505a-505d and produces a relatively high spatial resolution image of the object 123. The radiation sensor 500 also includes a sensing element 510 that is a single element sensing element that has higher penetration than the sensing element 505. Data read out from the sensing element 505 may be used to produce a high spatial resolution image of the object 123, and data read out from the sensing element 510 may be used to produce a high-penetration image of the object 123. The high-penetration image also may be considered to be a high signal-to-noise ratio image. The high spatial resolution image and the high-penetration image may be combined such that the radiation sensor 500 images the object 123 with both high penetration and high spatial resolution. The radiation sensor 500 may achieve high spatial imagery without sacrificing penetration.

The sensing element 505, which is a set of multiple smaller detectors 505a-505d, is placed in front of the sensing element 510, which is a single large detector. The sensing element 505 stops a small proportion of the x-ray photons that are incident on the sensing element 505. As discussed in greater detail below, data read out from each of the smaller detectors 505a-505d is used to generate a high resolution image of the object 123. The sensing element 510 stops the bulk of the x-ray photons that pass through the sensing element 505 and strike the sensing element 510. Data read out from the sensing element 510 may be used to generate a high-penetration image of the object 123.

In greater detail, the sensing element 505 may be a coplaner set of more than one sensing element that is arranged in plane that may be parallel to a plane in which the sensing element 510 is located. The plane on which the set of sensing elements is arranged has a normal in the direction “d,” which is the direction of propagation of an x-ray beam 515. The beam 515 is incident on the sensing element 505, and some of the energy in the beam 515 passes through the sensing element 505 to the sensing element 510.

In the example shown in FIGS. 5A and 5B, the sensing element 505 is a sensing element that includes a set of four coplanar sensing elements 505a-505d that are uniformly positioned in a rectangular grid. The sensing element 510 is a single sensing element. In this example, the sensing element 510 is a single large detector (for example, a detector with an active area of ten square millimeters (mm²) that is placed in front of the sensing element 505, which includes four smaller detectors. Referring to FIG. 5B, the arrangement of the four of sensing elements 505a-505d that make up the sensing element 505 is shown by the dotted lines.

The images of the object 123 obtained with the radiation sensor 500 are potentially of higher quality than images obtained by separately imaging the object 123 with either a single 10-mm² detector (such as the sensing element 510) or with four 5-mm² detectors (such as the sensing element 505). The smaller detectors 505a-505d in the sensing element 505 provide a higher resolution image than the single detector in the sensing element 510. When the imaged object 123 includes relatively high density material, the attenuation of the beam 515 is greater, which results in a low signal at the radiation sensor 500. In this instance, the sensing element 510 provides a better signal-to-noise ratio than the smaller detectors of the sensing element 505. In some implementations, the single detector of the sensing element 510 is wider than the sensing element 505 to further increase the number of x-ray photons that strike the sensing element 510, thus increasing the signal that is read out from the sensing element. In these implementations, the sensing elements included in the sensing element 505 may all be arranged within a perimeter that is defined by the size of the single detector of the sensing element 510.

In the example shown in FIGS. 5A and 5B, the sensing element 505 is positioned closer to the imaged object 123 such that the beam 515 strikes the sensing element 505 first. However, this is not necessarily the case. The ordering of the sensing elements 505 and 510 may be changed such that the single-element sensing element 510 is closer to the imaged object 123 and the sensing element 505 is located behind the sensing element 510 with respect to a direction of propagation of the beam 515. In some implementations, the sensing element 505 and the sensing element 510 may have different thicknesses along the direction “d.” In some implementations, the sensing element 505 and the sensing element 510 may be made from different materials. In some implementations, the sensing device 500 may have more than two sensing elements.

FIG. 6 shows a perspective view of an example system 600 that includes the radiation sensor 500. The radiation sensor 500 is coupled to the sensor electronics and computer 135 by coupling 150. As discussed above with respect to FIG. 3, the sensor electronics and computer 135 may be similar to the sensor electronics 350 and the data analysis system 360, and the coupling 150 may be similar to the data coupling 328. The coupling 150 individually couples the sensing element 510 and the each of the four sensing elements 505a-505d in the sensing element 505 to the sensor electronics and computer 135.

Similar to the sensing elements 322 discussed above with respect to FIG. 3, the sensing element 505 and the sensing element 510 may be scintillators. As discussed with respect to FIG. 3, scintillators produce visible light in response to being struck by x-ray photons, and the amount of visible light is proportional to the number of x-ray photons striking the scintillator. The visible light is detected by an optical sensor, such as a photodiode or a photomultiplier tube, that converts the detected visible light into an electrical signal. The electrical signal is read out through an analog to digital converter and the data stored in a computer readable format on a computer-readable storage medium.

The sensing element 505 includes four scintillator elements that may be coupled together by a material that is opaque to visible light. The material also may be an adhesive, such as glue, that persists on the scintillators and holds the four scintillator elements together to form the sensing element 505. In other implementations, the sensing element 505 may have more or fewer individual detector elements.

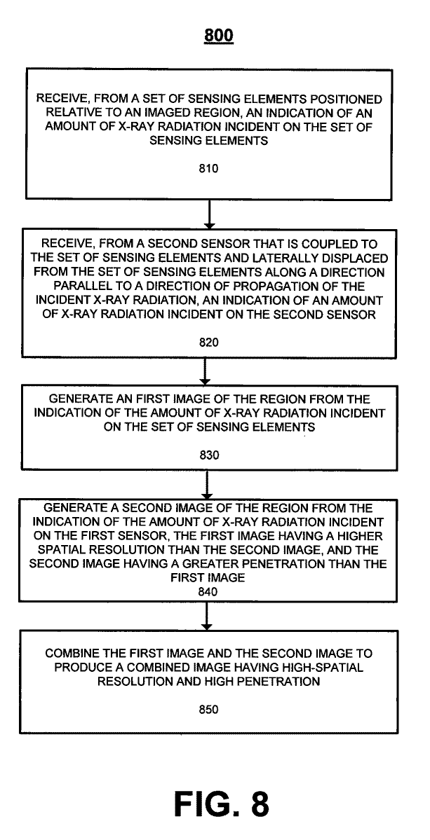

The sensing elements 505 and 510 each produce a representation of an amount of energy deposited on the sensing elements 505 and 510. The representations are provided to the sensor electronics and computer 135, which produces a high-resolution image with relatively low penetration from the data from the sensing element 505 and a high penetration image with relatively low spatial resolution from the data from the sensing element 510. Thus, the radiation sensor 500 provides both a high-resolution image and a high-penetration image. As discussed below with respect to FIG. 8, the high-resolution image and the high signal-to-noise image may be combined to create an image that has both high spatial resolution and high signal-to-noise.

FIG. 7A shows another side view of the radiation sensor 500. FIG. 7B shows another front view of the radiation sensor 500. FIGS. 7A and 7B show an example arrangement of visible light detectors 708a and 708b, which are used to detect visible light produced as a result of x-ray photons striking the sensor element 505, and visible light detector 710, which is used to detect visible light produced as a result of x-ray photons striking the sensing element 510. A visible-light detector 710 is coupled to the sensor element 510, and this visible-light detector 710 produces an electrical current that is proportional to the number of photons striking the sensing element 510. The visible-light detector 710 may be a combination of multiple detectors that act as one detector. Each of the small detectors 505a-505d included in the sensing element 505 are individually coupled to a visible-light detector. As shown in the side view of FIG. 7A, the small detector 508a is coupled to the visible-light detector 710a, and the small detector 508b is coupled to the visible-light detector 710b. As discussed above, the visible-light detector 708a and 708b sense visible light from the small detectors 508a and 508b to produce an electrical signal. The electrical signal may be digitized and the digitized value represents a pixel in an image of the region imaged by the sensor 500.

A collimator 720 also may be mounted on the perimeter of the sensor 500. The collimator 720 shields the sensor 500 from scattered radiation by blocking part of the beam 515. The collimator 720 may be made from a material, such as lead, that is impenetrable by x-rays.

Referring to FIG. 7B, a front view of the sensor 500 is shown. As shown, each of the small detectors 505a, 505b, 505c, and 505d are individually coupled, respectively, to visible-light detectors 708a, 708b, 708c, and 708d. The coupling may occur through an electromagnetic interaction between the small detector and the visible-light detector. For example, the coupling may be light passing from the scintillator in free-space and sensed by the visible-light detector. Some implementations may include a physical connection by, for example, a fiber optic cable.

Referring to FIG. 8, an example process 800 for generating an image having high spatial resolution and high penetration is shown. The image may be an image of an imaged region that includes the object 123. The region is imaged by exposing the region to the x-ray beam 515. The data to generate the image may be obtained from the sensor 500. An indication of an amount of x-ray radiation incident on a set of sensing elements is received (810). The set of sensing elements is the sensing element 505. The set of sensing elements is positioned relative to an imaged region. The indication of an amount of x-ray radiation may be the sum of digital values produced by digitizing an electrical signal produced by each of the visible-light detectors 708a, 708b, 708c, and 708d shown in FIGS. 7A and 7B.

An indication of an amount of x-ray radiation incident on a second sensor that is coupled to the set of sensing elements is received (820). The second sensor is the sensing element 510. The second sensor is displaced laterally, along a direction of propagation of the incident x-ray radiation, with respect to the set of sensing elements 505. Thus, the sensing element 510 may be coupled to and positioned directly behind the sensing element 505. The indication of an amount of x-ray radiation incident on the second sensor may be the digital value produced by digitizing an electrical signal produced by the visible-light detector 710 shown in FIG. 7A.

The sensor 500 images a portion of an imaged region, and the data from the sensor 505 represents the data of a pixel of am image of the entire imaged region. To produce the image of the entire region, a two-dimensional array of sensors 500 may be positioned relative to the imaged region, with each sensor 500 imaging a physical portion of the region that is represented as a pixel in the image of the region. In some implementations, the sensor 500, or an array of sensors 500, is scanned (for example, raster scanned) about the region to build up the image of the region.

A first image of the region is generated from the indication of the amount of x-ray radiation incident on the set of sensing elements (830). Because the set of sensing elements is made up of several small detectors, data from the set of sensing elements, along with data from other sets of sensing elements or from the set of sensing elements being scanned along the region, produces an image of relatively high spatial resolution. Thus, the first image is a relatively high spatial resolution image of the region.

A second image of the region is generated from the indication of the amount of x-ray radiation incident on the first sensing element (840). Because the first sensing elements is made up of a single detector with a relatively large active area, data from the first sensing element produces an image of relatively high penetration but low spatial resolution. Thus, the second image is a relatively high-penetration image of the region.

The first image and the second image are combined to produce a combined image that has a high spatial resolution and high penetration (850). The first and second images may be combined by separately displaying the first and separate images to a human operator.

In some implementations, the first and second images may be combined at the pixel level into one image that includes data from the first, high-spatial resolution image in pixels that correspond to portions of the imaged region that include low-density material and data from the second, high-penetration image in pixels that correspond to portions of the imaged region that include high-density material. Whether a pixel corresponds to a portion of the imaged region that includes high-density material may be determined from the attenuation caused by that portion of the imaged region. The attenuation may be determined by adding the amount of radiation sensed on the sensor 500 (from all of the smaller detectors in the set of sensing elements and from the larger first sensing element) and comparing the sum to the amount of x-ray radiation emanating from a source of the incident x-ray radiation.

The amount of attenuation caused by a portion of the imaged region corresponding to a particular pixel may be used to determine how to weight the pixel with a weighting that indicates how much emphasis to give to the corresponding pixel from high-penetration image as compared to the corresponding pixel from high-resolution image. Very dense areas of the imaged region are not well imaged in the high spatial resolution image, thus, pixels corresponding to portions of the imaged region that include very dense materials may be weighted such that the corresponding pixels in the high spatial resolution image is discounted. For example, a pixel that represents a very dense portion of the imaged region may receive a weight of “0” for the corresponding pixel in the high-resolution image and a weight “1” for the corresponding pixel in the high-penetration image. Thus, the corresponding pixel in the combined image would include only data from the corresponding pixel from the high-penetration image. The weighting may be determined by applying a function to the attenuation. For example, the weighting may be a logarithm of the attenuation. The weighting may be applied to a pixel by multiplying the weighting with the value associated with the pixel.

A number of implementations have been described. Nevertheless, it will be understood that various modifications may be made without departing from the scope of the disclosure. For example, the sensor 105 of FIG. 1 includes six sensing elements; however, other examples may include more or fewer sensing elements. In the example of FIGS. 5A and 5B, the sensing element 510 includes four sensing elements. However, in other implementations, more or fewer elements may be used.

What is claimed is:

1. A system for material discrimination, the system comprising:
multiple sensing elements coupled together to form a radiation sensor, the multiple sensing elements being coupled together along a direction parallel to a direction of propagation of radiation incident on the radiation sensor;
an adjustable border configured to be positioned between any two of the multiple sensing elements, the border defining a front region including a first set of coupled sensing elements and a back region including a second set of coupled sensing elements; and
a processor coupled to the radiation sensor and operable to:
receive an indication of an amount of energy incident on the radiation sensor, and
select a position of the border based on the amount of the energy.

2. The system of claim 1, wherein the amount of energy incident on the radiation sensor is the total amount of energy incident on the multiple coupled sensing elements.

3. The system of claim 1, wherein the energy incident on the radiation sensor travels through a region, and the processor is further operable to generate an image of the region based on the amount of energy incident on the radiation sensor.

4. The system of claim 3, wherein the processor is further operable to estimate a density of the region based on the image, and the position of the border is selected based on the estimated density.

5. The system of claim 1, wherein, to determine an amount of energy incident on the radiation sensor, the processor is operable to determine a distribution of energy incident on the sensing elements.

6. The system of claim 5, wherein the distribution is an amount of energy incident on each of the sensing elements, and the processor is operable to select the position of the border based on the distribution of energy.

7. The system of claim 5, wherein, to select the position of the border, the processor is further operable to determine a comparative value of the energy incident on a sensing element with respect to the energy incident on the remaining sensing elements.

8. The system of claim 3, wherein the comparative value is a ratio.

9. The system of claim 1, wherein one of the first set of coupled elements and the second set of coupled elements is a single sensing element.

10. The system of claim 1, wherein the first set of couple sensing elements and the second set of sensing elements include the same number of sensing elements.

11. The system of claim 1, wherein:
each of the coupled sensing elements generates a signal representing an amount of energy incident on the sensing element, and
each of the coupled sensing elements is individually coupled to the processor.

12. The system of claim 1, wherein one of the coupled sensing elements is a filter that modifies a spectral energy or intensity of radiation passing through the filter.

13. The system of claim 1, wherein the multiple sensing elements are coupled together by a physical connection.

14. The system of claim 1, wherein each of the multiple sensing elements has the same thickness in the direction of propagation.

15. The system of claim 1, wherein at least one of the multiple sensing elements is an array of sensing elements arranged within a plane having a normal direction that is parallel to a direction of propagation of the incident radiation.

16. A system for material discrimination, the system comprising:
a single-beam source of x-ray radiation having an energy spectrum and a peak energy;
a radiation sensor comprising:
multiple sensing elements that are responsive to incident radiation and coupled together to form the radiation sensor, and
an adjustable border configured to be positioned between any two of the multiple sensing elements, the border defining a front region including a first set of coupled sensing elements and a back region including a second set of coupled sensing elements; and
a processor coupled to the radiation sensor and operable to:
receive an indication of an amount of energy incident on the radiation sensor, and
select a position of the border based on the amount of the energy.

17. The system of claim 16, wherein the energy incident on the radiation sensor emanates from a region, and the processor is further operable to:
determine a ratio of an amount of energy incident on the front region of the radiation sensor to the amount of energy incident on the back region of the detector, and
determine an effective atomic number of the material based on the ratio.

18. A method of performing material discrimination, the method comprising:
receiving a representation of an amount of energy incident on a radiation sensor formed from multiple sensing elements coupled together along a direction parallel to a direction of propagation of the incident radiation, the radiation sensor having an adjustable border positioned between any two of the multiple sensing elements;
determining, from the representation, an amount of energy incident on the radiation sensor, the radiation emanating from a region scanned by a single-beam x-ray source;
selecting a position of the border based on the amount of energy incident on the radiation sensor; and
determining, after selecting the position of the border, an absorption characteristic of a region imaged by the radiation sensor.

19. The method of 18, wherein determining an amount of energy incident on the radiation sensor comprises determining a distribution, among the coupled sensors, of the amount of energy incident on the radiation sensor.

20. The method of claim 18, wherein the absorption characteristic of the region varies, and further comprising selecting a second position of the border to account for the variation.

21. The method of claim 18, further comprising:
generating an image based on the amount of energy incident on the radiation sensor, the image representing an amount of attenuation caused by an object in the region imaged by the sensing elements; and
estimating a density of the object based on the image, and
wherein the position of the border is selected based on the density.

22. A device for imaging a region, the device comprising:
a first sensing element having an active area within a first plane that defines a normal direction; and
a set of sensing elements arranged relative to each other within a second plane that is displaced laterally, in the normal direction, relative to the first plane,
wherein:
the first sensing element and the set of sensing elements are penetrable by x-ray radiation,
data from the set of sensing elements produces an image of higher spatial resolution than an image produced by the first sensing element,
data from the first sensing element produces an image of higher penetration than an image produced by the set of sensing elements, and
the active area of the first sensing element is larger than any of the sensing elements included in the set of sensing elements.

23. The device of claim 22, further comprising:
a first interface coupled to the first sensing element and configured to provide an indication of an amount of radiation incident on the active area; and
a second interface coupled to each sensing element in the set of sensing elements and configured to provide an indication of an amount of radiation incident on the set of sensing elements.

24. The device of claim 23 further comprising a processor operable to:
receive the indication from the first interface,
receive the indication from the second interface,
generate a high-penetration image of a region based on the indication from the first interface,
generate a high-spatial resolution image of the region based on the indication from the second interface, and
combine the high-penetration image and the high-spatial resolution image.

25. The device of claim 22, wherein the first sensing element and the set of sensing elements are physically coupled.

26. The device of claim 22, wherein the first plane is parallel to the second plane.

27. A method of imaging a region, the method comprising:
receiving, from a set of sensing elements positioned relative to an imaged region, an indication of an amount of x-ray radiation incident on the set of sensing elements;
receiving, from a second sensor that is laterally displaced from the set of sensing elements along direction parallel to a direction of propagation of the incident x-ray radiation and coupled to the sensing elements, an indication of an amount of x-ray radiation incident on the second sensor;
generating a first image of the imaged region from the indication of the amount of x-ray radiation incident on the set of sensing elements;
generating a second image of the imaged region from the indication of the amount of x-ray radiation incident on the first sensor, the first image having a higher spatial resolution than the second image and the second image having a higher penetration than the first image; and
combining the first image and the second image to produce a combined image having high spatial resolution and high penetration.

28. The method of claim 27, further comprising:
determining an attenuation caused by a portion of the imaged region represented by a pixel of the first image and a pixel of the second image;
calculating a weighting based on the attenuation; and wherein combining the first image and the second image comprises:
applying the weighting to a corresponding pixel of the first image,
applying the weighting to a corresponding pixel of the second image, and
generating a combined image from the weighed pixels.
